(19) United States
(12) Patent Application Publication
(10) Pub. No.: US 2013/0265634 A1
(43) Pub. Date: Oct. 10, 2013

(54) Raman Amplifiers

(71) Applicants: Ian Peter McClean, Brixham (GB); Peter Wigley, Corning, NY (US)

(72) Inventors: Ian Peter McClean, Brixham (GB); Peter Wigley, Corning, NY (US)

(73) Assignee: OCLARO TECHNOLOGY LIMITED, Caswell Towcester Northamptonshire (GB)

(21) Appl. No.: 13/993,809

(22) PCT Filed: Dec. 20, 2011
(86) PCT No.: PCT/GB2011/052534

§ 371 Date: Jun. 13, 2013

(30) Foreign Application Priority Data
Dec. 22, 2010 (GB) 1021677.8

(51) Int. Cl. H01S 3/102; H01S 3/30

(52) U.S. Cl. CPC H01S 3/1024; H01S 3/302
USPC 359/334; 359/341.3

(57) ABSTRACT

A pump unit (402) for a Raman amplifier (400) including an optical fibre (401) carrying an optical signal (420) is disclosed. The pump unit includes at least two light sources (411, 412, 431, 432) for emitting light at different wavelengths into the fibre to induce Raman gain of the optical signal passing along the fibre, and a controller (409) for providing pulses to each of the light sources to control when they do and do not emit light. The controller is configured to control the width of the pulses to control the total power of the light emitted into the fibre.

### TECHNICAL FIELD

The present invention relates to Raman amplifiers and, more particularly to control of pump lasers for such amplifiers.

### BACKGROUND

In this specification the term “light” will be used in the sense that it is used in optical systems to mean not just visible light, but also electromagnetic radiation having a wavelength outside that of the visible range.

Raman amplification is a technique in which high power light is injected into a host material, creating the ability to provide gain to optical signals on the host material via a stimulated Raman scattering (SRS) process. In optical fibre communications, Raman amplifiers have been used to provide Raman gain in an optical fibre span at C and L bands wavelengths. Raman amplifiers are generally used independently or alongside other optical amplifiers such as erbium doped fibre amplifiers (EDFAs).

Raman amplifiers have certain advantages such as the ability to provide gain at any wavelength, lower Noise Figure (NF) than systems having only EDFAs, and wideband operation if pump lasers of more than one wavelength are multiplexed together. However, Raman amplifiers suffer from certain problems, including stimulated Brillouin scattering (SBS), pump relative intensity noise (RIN) transfer and pump to pump energy transfer. These influence amplifier performance, create an uneven optical signal to noise ratio (OSNR) wavelength profile and can have four-wave mixing (FWM) issues.

SBS is a non linear narrow band scattering process that occurs when the power of light in an optical fibre span increases above a threshold. SBS is induced by light that has been injected into the fibre for the Raman gain process, and thus techniques to reduce SBS are useful for realising efficient Raman gain. In order to maintain the SBS threshold as high as possible, either the power in any mode needs to be low or the power needs to be spread amongst several longitudinal modes.

Spreading out the pump light amongst several longitudinal modes has the effect that the narrow bandwidth power is reduced, although the total pump power is maintained. This is generally achieved by using a Fibre Bragg Grating (FBG) placed on the output of a pump laser (A. Hamanaka et al Proc ECOC 1996 p 1.119). It is also shown that relatively long cavities are required in FBG lasers to reduce SBS by operating the laser in a coherence collapse regime. This therefore randomises the phase of an optical feedback and increases the width of the longitudinal modes.

Another consideration for Raman amplifiers is the RIN transfer from a pump laser to Raman gain. Due to the fast Raman process, any noise on the pump laser can be transferred to the gain of optical signals in the fibre. Generally, the RIN is induced by resonances between the pump laser and the FBG. It has been demonstrated that a cavity length is inversely proportional to a resonance frequency interval, and thus for low RIN, a short cavity is desirable. Therefore it is difficult to design pump lasers to meet both the low RIN and high SBS threshold.

An important factor for Raman amplifiers is that the pump laser does not go to single mode (SM) operation at any operating condition. This becomes more difficult when the pump output power is low and the reflection from the FBG is also low. This allows other cavity reflections to dominate and create single mode lasing.

One technique to address this is to add a small dither frequency to the pump laser for broadening the laser bandwidth in all conditions, which in turn increases the SBS threshold. This is described in U.S. Pat. No. 5,477,368 and U.S. Pat. No. 6,215,809.

Another problem for Raman amplifiers is that the stimulated Raman scattering (SRS) process occurs between any light travelling within the optical fibre. The predominate energy is transferred when short wavelength pump light provides gain to long wavelength pump light and short wavelength optical signals provide gain to long wavelength optical signals.

This means that the short wavelength pump lasers are generally provided at much higher pump powers than the long wavelength pump lasers. This means that an uneven pump power is required, with higher powers for the short wavelength pump lasers than is required purely to provide gain at the short wavelength signals. This demands higher performance pumps to overcome pump to pump SRS.

Furthermore, since the SRS process takes place along the optical fibre, the long wavelength pump light extends further into the span than the short wavelength pump light when a pump to pump SRS process occurs. FIG. 1a schematically illustrates pump to pump power transfer between two pump lasers due to the SRS process. Light 104 emitted by one laser at a long wavelength λ2 falls near the peak of a Raman gain spectrum 102 from light 103 emitted by the other laser at a shorter wavelength λ1. Therefore, some energy of that short wavelength light 103 (λ1) is transferred to the long wavelength light 104 (λ2).

This means that the long wavelength signals have higher gain along lengths of the fibre than short wavelength signals, and so the NF is reduced in comparison to the short wavelength signals. This creates a tilted OSNR profile across the wavelength with the short wavelength signals having worse OSNR. This problem is described in U.S. Pat. No. 6,456,426 and shown in FIG. 1b, which illustrates pump powers injected backwards across a span of optical fibre from the pump lasers of FIG. 1a. The pump power 106 from the long wavelength (λ2) light 104 increases along a portion of the span compared to the pump power 105 from the short wavelength (λ1) light 103 as energy is transferred from pump 103 to 104. Pump power 106 continues to gain energy towards the front of the fibre from pump power 105 so that pump power 106 is higher than 105 along the fibre and thus gives more gain to longer wavelength channels close to the front end of the fibre.

The tilted OSNR problem can be addressed by using a time division multiplexing (TDM) scheme in which each pump laser, or set of pump lasers, is turned on at a different time. FIG. 2 is a schematic illustration of a conventional Raman amplifier system 200 using a TDM scheme. The system 200 is used in a fibre optic communications link having a span of optical fibre 201. The system 200 has a pump unit 202 which is located at the back of the span 201 for emitting counter-propagating light. The pump unit 202 has a monitor 207, a controller 209, two pump lasers 211, 212, an optical unit 210, a signal/pump combiner 213 and a tap 214. The pump unit 202 is arranged such that the lasers 211, 212 inject counter-propagating light 221 into the fibre 201 through the optical unit 202 and the signal/pump combiner 213. The counter-propagating light 221 travels in the opposite direction to optical signals 220 passing along the fibre 201. The pump lasers 211, 212 are coupled together and controlled by the controller 209. When the lasers 211, 212 are ON, the Raman gain is controlled by changing the pump powers of the lasers 211, 212 by the controller 209. Some of the optical signals 220 divert through the tap 214 to the monitor 207 which measures the optical power of the diverted optical signals. The controller 209 uses the measured optical power for setting the pump powers of the lasers 211, 212. The duty cycles 230, 231 of the pump powers are arranged such that the lasers 211, 212 are not both ON at the same time. The duty cycles 230, 231 are normally set so that neither laser is ON for more than 50% of the time. Therefore, there is no interaction between the pump light of the two lasers 211, 212. One laser 211 emits light having a relatively short wavelength and the other laser 212 emits light having a long wavelength. This means both pump light will pass along the fibre length at the same energy and all signal channels essentially achieve the same NF, providing a flat OSNR profile at the end of the fibre 225.

Generally the speed of the Raman amplifier system described above is determined by the modulation transfer of the laser to optical signal gain. A RIN transfer response can determine the control frequency of a pump laser used in the system. FIG. 3 schematically compares the RIN transfer responses 301, 302 for a co-pump laser and a counter-pump laser, respectively, which could be used in such a Raman amplifier system. The actual response is fibre type dependent. It can be seen that the RIN response 301 is higher for the co-pump laser than the RIN response 302 of the counter-pump laser. This is because the co-pump response 302 relies upon dispersion to provide walk off between the pump light and optical signals to remove RIN transfer effects. It is shown for the counter-pump laser that, as long as the repetition rate is just above 1 Mhz, no modulation transfer will be passed to signal gain. For the co-pump laser the modulation rate changes to several tens of MHz.

Similar TDM schemes have been described in various documents such as: “Novel Ultra-Broadband High Performance Distributed Raman Amplifier Employing Pulse Modulation” Fludger et al OFC 2002 WB4; “Time-Division multiplexing of pump wavelengths to achieve, flat backward-pumped Raman Gain” Mollenauer et al Opt Letter 27(8) p 592 2002; U.S. Pat. No. 6,456,426; U.S. Pat. No. 6,914,716; U.S. Pat. No. 6,611,368 and U.S. Pat. No. 7,397,233. In these documents, the TDM scheme has a fixed duty cycle and the power of the pump lasers is modified by a drive current to provide different Raman gains.

The problem of a pure TDM approach is that the power control is still achieved through varying the amplitude of the pump power. Therefore, when low gains are required, the pump power will be low and the reflection from the FBG is also low, providing the risk of single mode locking. The technique described in U.S. Pat. No. 7,379,233 attempts to reduce the amount of pump to pump interaction by reducing the duty cycle for multiple pump lasers below 50% and carefully controlling the ON time of the pump lasers. Although there are pump to pump energy transfers, these are smaller than if all pump lasers were ON at the same time and so the short wavelength pump lasers do not have to be as high power nor does the difference in light transmission along the fibre differ as much as is shown in FIG. 1b. This arrangement reduces detrimental interaction, but at the expense of a larger pump power than a pure TDM scheme. In the arrangement of U.S. Pat. No. 7,379,233, the duty cycles of the pump powers are always equal or multiples of a fixed period.

An alternative TDM approach is to sweep a pump laser across wavelength quickly and achieve a wideband low gain ripple and flat OSNR performance, as described in U.S. Pat. No. 6,914,716; L. F. Mollenauer et al “Time-Division multiplexing of pump wavelengths to achieve ultra-broadband, flat, backward-pumped Raman gain” Opt Lett 27 2002 p 592; and J. W. Nicholson et al “A swept-wavelength Raman pump with 69 MHz repetition rate” Proc OFC 2003.

### SUMMARY OF THE INVENTION

According to one aspect of the present invention, there is provided a pump unit for a Raman amplifier having an optical fibre carrying an optical signal. The pump unit comprises at least two light sources for emitting light at different wavelengths into the fibre to induce Raman gain of the optical signal passing along the fibre, and a controller for providing pulses to each of the light sources to control when they do and do not emit light. The controller is configured to control the width of the pulses to control the total power of the light emitted into the fibre. The controller is also configured to optimise overlap times during which the light sources are activated simultaneously so that the overlap time between the light sources is minimised when light from one light source falls near the peak of a Raman gain spectrum produced from light of another light source.

The controller may comprise a pulse width modulation, PWM, unit for varying the width of the pulses. The controller may be configured to vary the duty cycles of the pulses to each of the light sources in response to changes in gain conditions, bandwidth and/or channel allocation in the amplifier.

It will be appreciated that, in general, the pulses supplied to the different light sources may be at different times to each other, although some overlap is possible when more than one light source is on simultaneously. The controller may be configured to optimise overlap times during which two or more light sources are activated simultaneously.

The pump unit may be configured to allow a long overlap time between two light sources when light from the two sources does not interact strongly.

Each of the light sources may be configured to emit light at a high pump power. Each of the light sources may be configured to operate in multi longitudinal mode. Each of the light sources may be configured to operate in coherence collapse mode.

The controller and the light sources may be provided in an integrated package.

The invention also provides a Raman amplifier system comprising an optical fibre carrying an optical signal and a pump unit as described above.

According to another aspect of the present invention, there is provided a Raman amplifier assembly having an optical fibre carrying an optical signal. The assembly comprises at least two light sources for emitting light at different wavelengths into the fibre to induce Raman gain of the optical signal passing along the fibre, and a controller for providing pulses to each of the light sources to control when they do and do not emit light. The controller is configured to control the width of the pulses to control the total power of the light emitted into the fibre. The controller is also configured to optimise overlap times during which the light sources are activated simultaneously so that the overlap time between the light sources is minimised when light from one light source falls near the peak of a Raman gain spectrum produced from light of another light source.

According to another aspect of the present invention, there is provided a method of controlling a pump unit used in a Raman amplifier system having an optical fibre for carrying an optical signal. The method comprises emitting light at different wavelengths into the fibre to induce Raman gain of the optical signal passing along the fibre by means of light sources, providing pulses to each of the light sources to control when they do and do not emit light, varying the width of the pulses to control the total power of the light emitted into the fibre, and optimising overlap times during which the light sources are activated simultaneously so that the overlap time between the light sources is minimised when light from one light source falls near the peak of a Raman gain spectrum produced from light of another light source.

The invention also provides a computer program configured, when run by a controller of a pump unit as described above, to cause the pump unit to carry out the method described above.

### BRIEF DESCRIPTION OF THE DRAWINGS

Some preferred embodiments of the invention will now be described by way of example only and with reference to the accompanying drawings, in which:

FIG. 1a illustrates pump to pump power transfer between two pump lasers due to the SRS process;

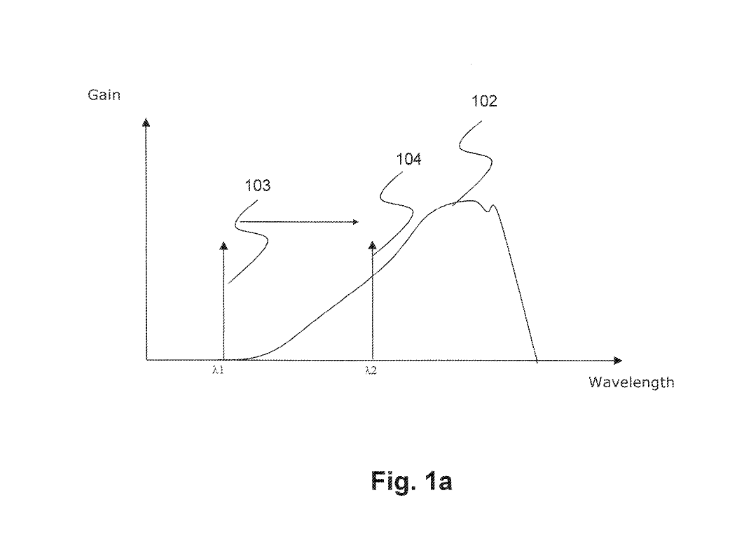

FIG. 1b illustrates pump powers injected across a span of optical fibre from the pump lasers of FIG. 1a;

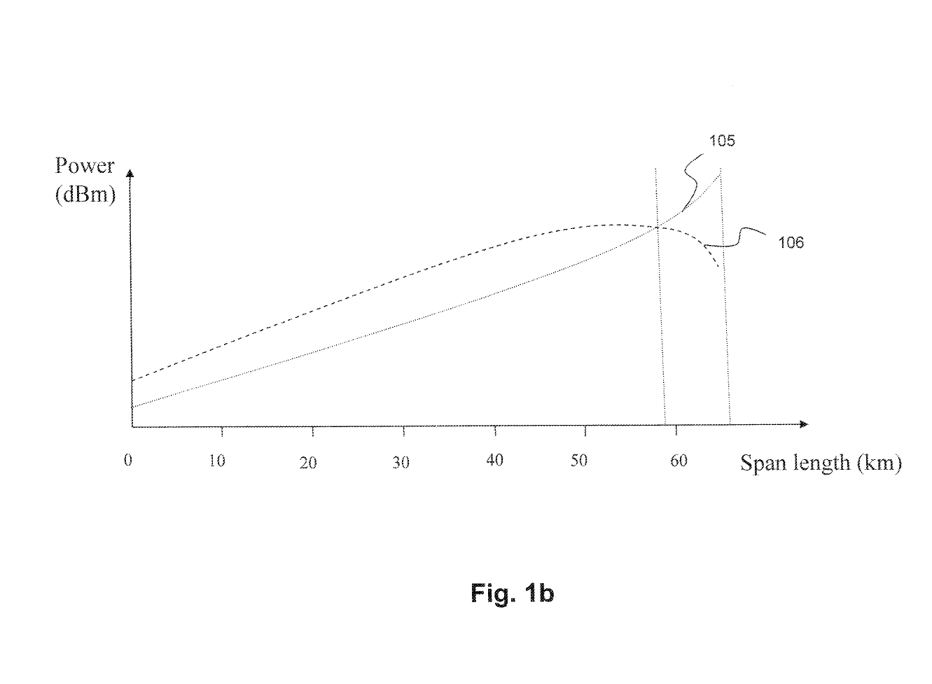

FIG. 2 is a schematic illustration of a conventional Raman amplifier system;

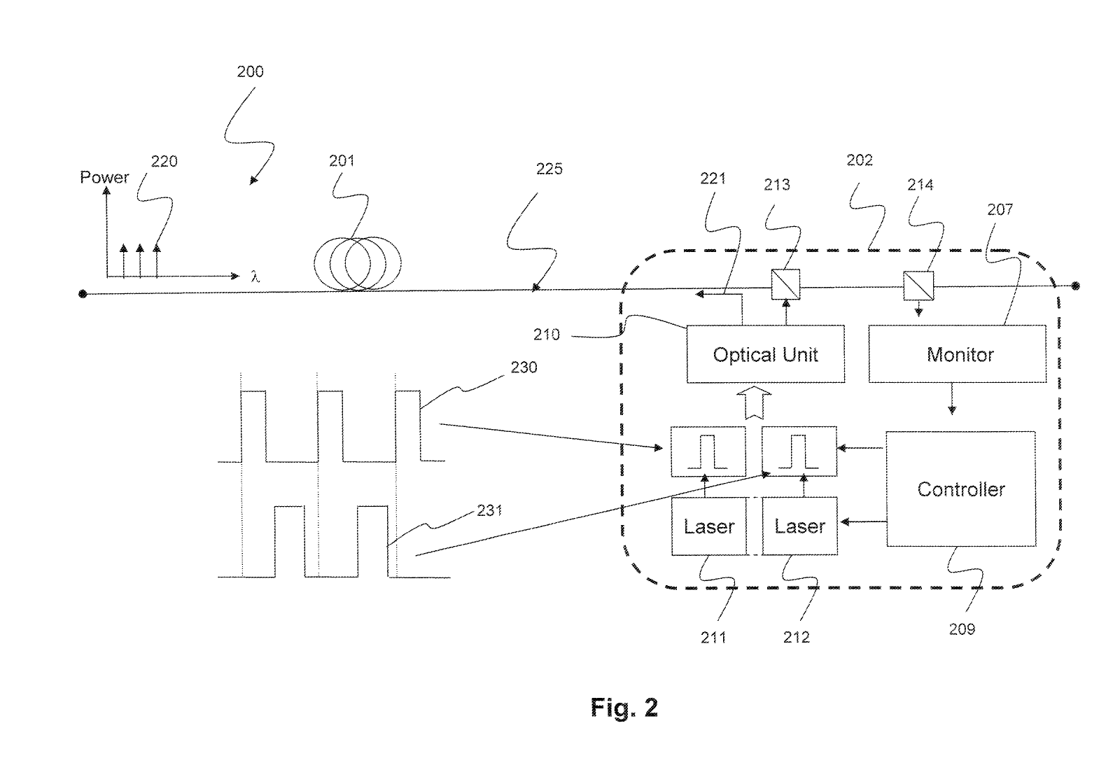

FIG. 3 schematically compares the RIN transfer responses for a co-pump laser and a counter-pump laser used in a Raman amplifier system;

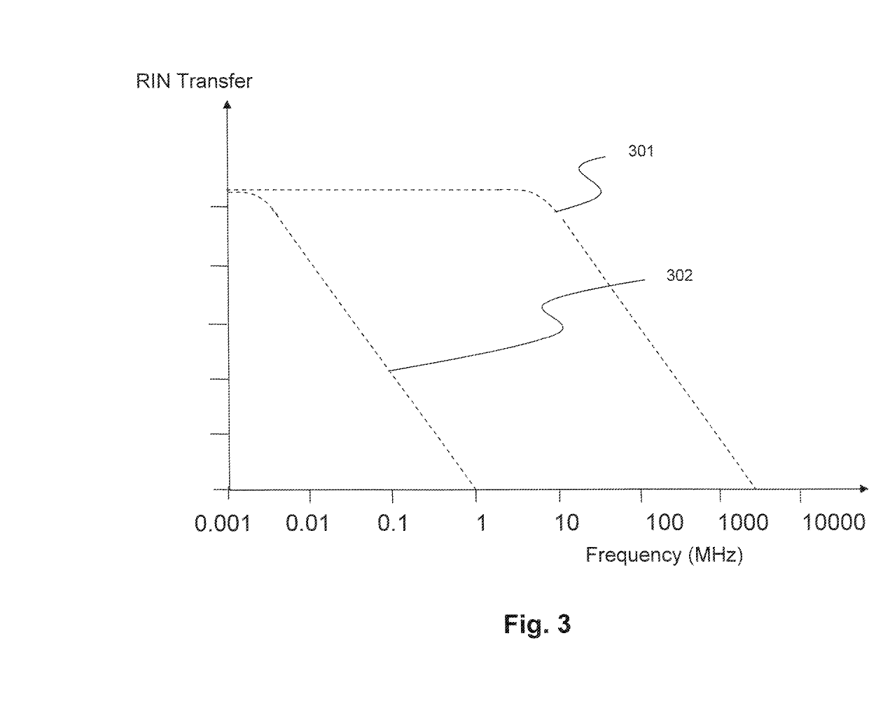

FIG. 4 is a schematic illustration of a Raman amplifier system;

FIG. 5 illustrates a pump power spectrum of one of the lasers shown in FIG. 4 operating in multi-longitudinal modes;

FIG. 6a is a schematic illustration of a suitable scheme for enabling time division multiplexing between the pump lasers of FIG. 4;

FIG. 6b is a schematic illustration of an alternative scheme for enabling time division multiplexing three of the lasers of FIG. 4; and

FIG. 7 is a schematic illustration of Raman gain spectra produced by pump lasers at different wavelengths.

### DETAILED DESCRIPTION OF THE DRAWING

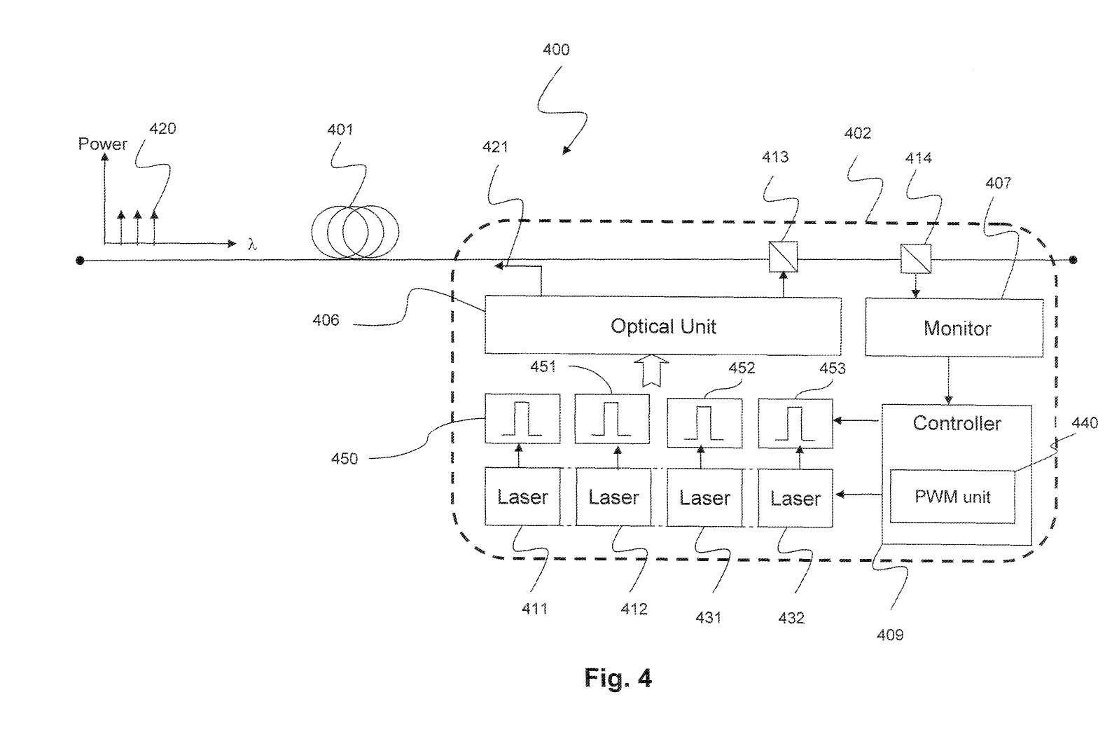

FIG. 4 is a schematic illustration of a Raman amplifier system 400 having a span 401 of optical fibre carrying optical signals 420. The system 400 includes a pump unit 402 for emitting counter-propagating pump light into the span 401. The pump unit 402 includes an optical unit 406 through which counter propagating pump light 421 is injected into the fibre 401, a monitor 407, a signal/pump combiner 413 and a tap coupler 414. In this example, the pump unit 402 has a controller 409 having a PWM unit 440. The pump unit 402 also includes four pump lasers 411, 412, 431, 432 coupled together which are capable of supplying pump light at different pump powers into the span 401 to induce Raman gain of the optical signals 420 in the span 401. It will be appreciated that the term “pump light” as used herein refers to light intended to induce amplification of the optical signal, but which does not normally “pump” the fibre to cause a population inversion, as is the case with conventional amplifiers. However the term is used herein for consistency with the art.

The controller 409 supplies pulses to drive the lasers 411, 412, 431, 432 and can vary the width of the pulses in order to control the total output power from the pump unit 402. The controller 409 essentially controls whether each laser is ON or OFF. Although the PWM unit 440 is part of the controller 409 in FIG. 4, it will be appreciated that the PWM unit 440 can be a discrete unit performing the same operation described above. As will become apparent, the controller 409 controls the pulses to the different lasers in such a way as to ensure a form of time division multiplexing between the lasers 411, 412, 431, 432.

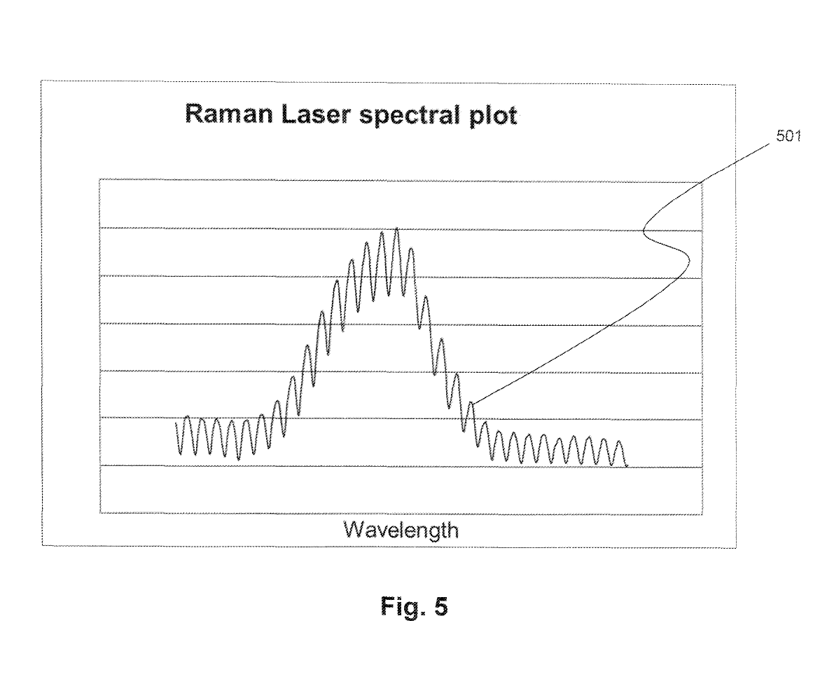

FIG. 5 illustrates a pump power spectrum 501 of one of the pump lasers of FIG. 4 operating in multi-longitudinal modes. If the laser is arranged to run at high power, it should always run in a coherence collapse mode, increasing the SBS threshold. Since the output power of the unit is controlled by pulse widths, rather than pulse amplitude, all of the lasers operate at high power when they are ON.

The controller 409 controls the duty cycles 450, 451, 452, 453 of the pump powers of the lasers 411, 412, 431, 432. The output power from the pump unit 402 is controlled by controlling the width of pulses determining which laser is ON or OFF. It will be appreciated that, when the duty cycles 450, 451, 452, 453 are set to 100% at high gains, the lasers 411, 412, 431, 432 will be ON all the time and there is a full cross over between all of the lasers. However, if the duty cycles are set to 25% so that only one of the lasers is turned ON at any one time, four times as much pump power will be required to get the same gain in a counter pumped amplifier.

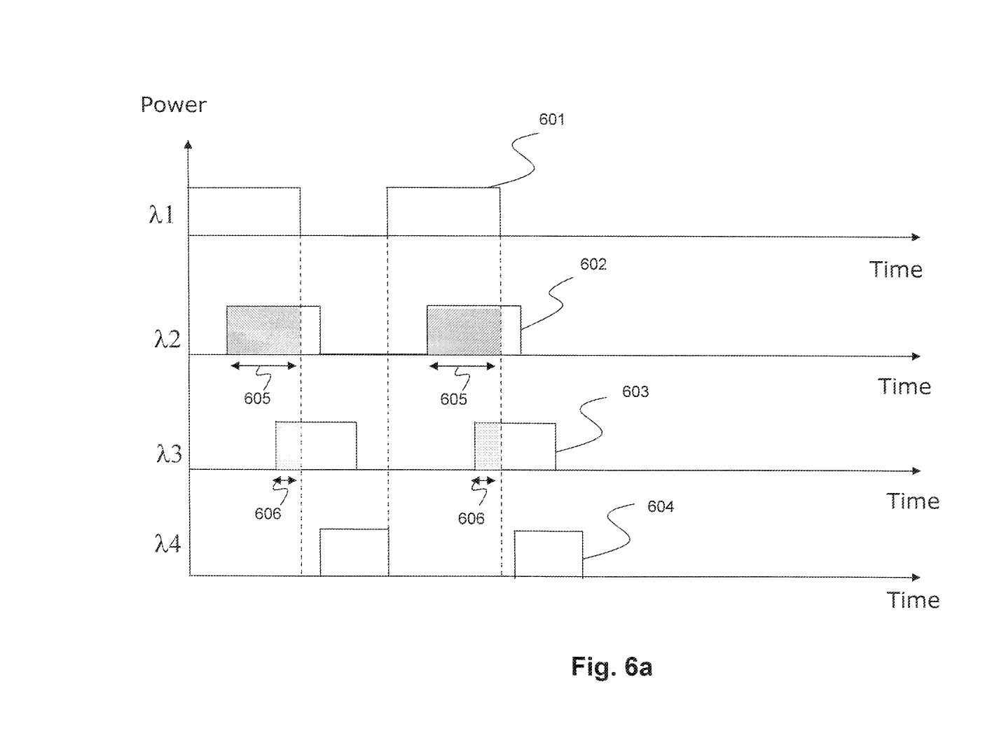

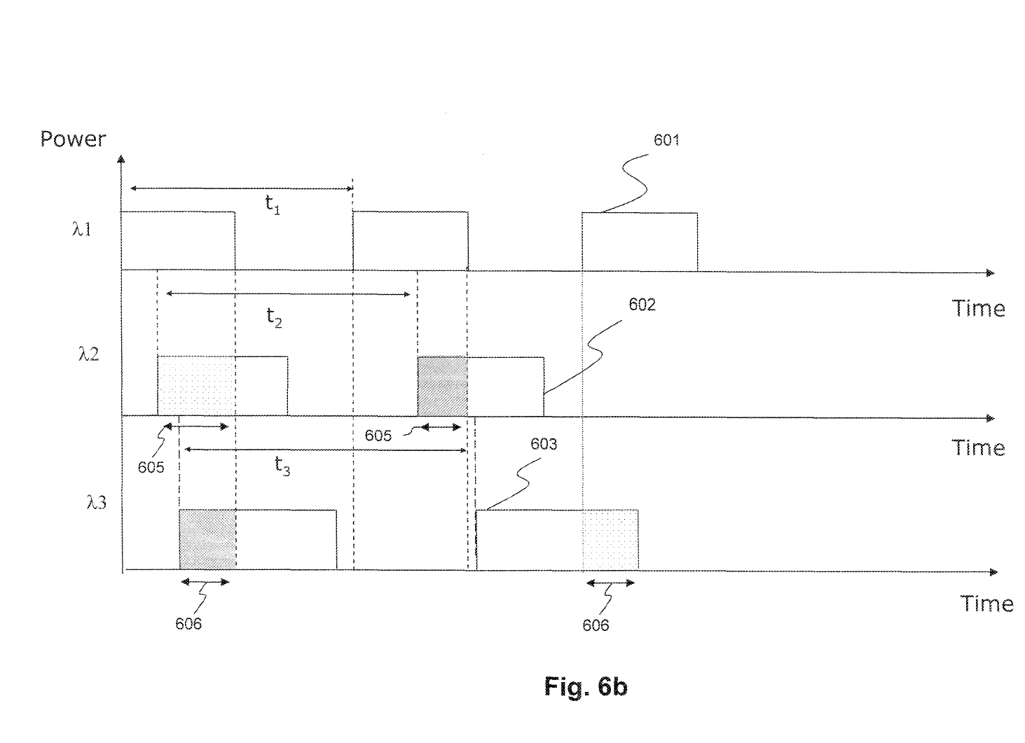

Although it is desirable to eliminate pump to pump interaction entirely, in certain circumstances some overlap between different pump ON periods can be tolerated in order to increase the duty cycle of at least some of the pump lasers, thus improving the Raman gain performance without requiring as high a pump power as the case when no pumps are on at the same time. This means that there may be some interaction time between pump lasers, but it is still possible to achieve a beneficial improvement in performance. FIG. 6a is schematic illustration of a scheme suitable for optimising Raman gain. In this example, pulses 601, 602, 603, 604 of high pump powers produced by the pump lasers 411, 412, 431, 432 of FIG. 4 at different (increasing) wavelengths, λ1, λ2, λ3, λ4, are shown against time. As can be seen, an overlap time 605 between pulses 601, 602, during which lasers 411 and 412 are both ON (and thus during which light from both lasers can interact), at wavelengths λ1 and λ2 is high. However, the pump to pump interaction is low, because the wavelengths λ1 and λ2 are close together. The overlap time 606 between pulses 601 at λ1 and 606 at wavelength λ3 is shorter than that between pulses 601, 602, but the pump to pump interaction between wavelengths λ1 and λ3 is higher than that between wavelengths λ1 and λ2 so a reduced overlap time is beneficial. Pump to pump interaction is the highest between light at wavelengths λ1 and λ4 due to the power transfer from light of the shortest wavelength λ1 to light of the longest wavelength λ4. Therefore the scheme is designed so that there is no overlap time between the pulse 604 at wavelength λ4 and the pulse 601 at wavelength λ1. The duty cycle chosen is dependent upon the amount of pump to pump interaction between each pump laser. This choice can be varied dynamically as gain conditions, bandwidth and channel allocation change in the network. Since the duty cycles can be flexibly controlled, more pump lasers can be incorporated closer together to provide overall flatter gain than conventionally acceptable

FIG. 6b is an alternative scheme for enabling time division multiplexing between the first three of pump lasers 411, 412, 431 of FIG. 4. In this example, the fourth laser 432 of FIG. 4 is turned OFF completely. Many features of the illustration of FIG. 6b are the same as those of FIG. 6a and therefore carry the same reference numbers. As can be seen, switching periods t1, t2, t3 for the pulses 601, 602, 603 are different for each laser. Pulses 602 at wavelength λ2 are wider than those at wavelength λ1. Similarly, pulses 603 at wavelength λ3 are wider than those at wavelength λ2. The selection of different switching periods, t1, t2, t3, enables the overlap time 606 between pulses 601 and 603 to be minimised despite the wide pulses 603.

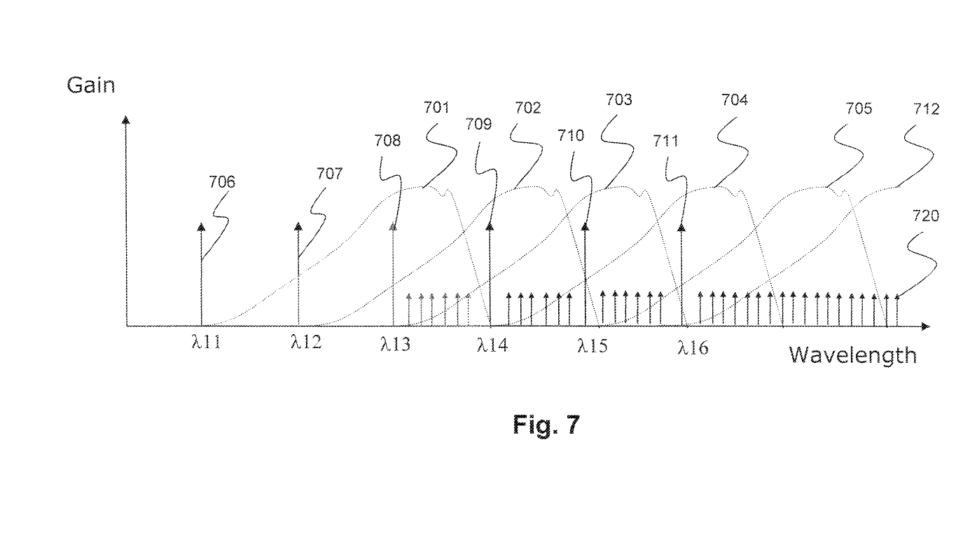

A further benefit of this scheme is that much wider bandwidth operation with Raman amplification can be achieved than with a scheme with all pumps ON. FIG. 7 is a schematic illustration of Raman gain spectra produced by pump lasers at different wavelengths. In this example, six pump lasers are used which emit pump light 706, 707, 708, 709, 710, 711 at six different, increasing, wavelengths, λ11 to λ16. The pump light at each wavelength has a corresponding Raman gain spectrum 701, 702, 703, 704, 705, 712. Signal channels 720 are also shown which fall within the Raman gain spectra of light at different wavelengths. As can be seen, there will be pump to pump interactions between light at wavelengths λ11 and λ13. Pump to pump interaction is relatively high between light 706, 708 at wavelengths λ11 and λ13 as light 708 as wavelength λ13 falls near a peak of the Raman gain spectrum 701 from light 706 at wavelength λ11. Therefore a PWM scheme (not shown in this figure) is designed so that the laser at wavelength λ11 is not switched ON at the same time as the laser at wavelengths λ13 to minimise any overlap time between these lasers. Furthermore, it can be seen that there is no pump to pump interaction between light at wavelengths λ11 and λ14 to λ16, since light 709, 710, 711 at wavelengths λ14 to λ16 falls outside the Raman gain spectrum 701 from light 706 at wavelength λ11. In such a case, the scheme does not need to minimise any overlap times between the lasers of these wavelengths.

In FIG. 7, there are pump to pump interactions for light at wavelengths λ14 to λ16. The interaction is particularly high between light 709, 711 at wavelengths λ14 and λ16 as light 711 at wavelength λ16 falls near a peak of the Raman gain spectrum from light at wavelength λ14. The scheme therefore has to make sure that the laser at wavelength λ14 is not turned ON at the same time as the laser at wavelength λ16 to minimise any overlap time between them.

It will be appreciated that the wavelengths λ11 to λ16 can be spread widely so that optical signals 720 can be incorporated near light at relatively long wavelengths, e.g. λ13 to λ16, (with an appropriately chosen guardband). Pump to pump interactions are minimised by the PWM scheme providing a wideband amplification process.

Thus the arrangement described above incorporates the benefits of a PWM scheme with a TDM scheme applied to a Raman amplification process. This arrangement may be capable of providing TDM OSNR improvement and FWM reduction, and also maintaining each pump laser at a high power and in a coherence collapse, multimode (MM) state. If there is a risk that the pump lasers will go into single mode operation then this is unlikely to last more than a single pump pulse since then next pulse will disrupt the dominant cavity mode, resulting in the multimode operation for the pump laser once again. Due to an averaging effect in the counter-pumped amplifier it may not be a problem if the laser is in single mode for a single period as long as the actual locked mode is random. Therefore the averaging effects will still provide the required Raman gain.

The PWM unit may be incorporated in a module or used as a digital source where a control circuit is part of the pump laser. In this case, such an arrangement is capable of providing inherent benefits like no pump kink and no pump threshold.

Since the PWM unit may operate as a variable duty cycle scheme, it provides advantages such as a flat response and wide bandwidth operation. The PWM unit may vary the pump power duty cycle and the switching period, without the need of any amplitude modulation, as long as the modulation frequency is above the limits defined by the co or counter-pump laser.

It will be appreciated that the Raman amplifier arrangements as described hereinbefore are only suitable representations, and that other combinations of units, lasers, controllers, monitors, taps and combiners, and other suitable functional blocks, could be used to provide a similar function.

It will be noted that the foregoing description is directed to Raman amplifier arrangements having three or four pump lasers. However, it will be appreciated that the arrangements can have other suitable number of pump lasers.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A pump unit for a Raman amplifier having an optical fibre carrying an optical signal, the pump unit comprising:
at least two light sources for emitting light at different wavelengths into the fibre to induce Raman gain of the optical signal passing along the fibre; and
a controller for providing pulses to each of the light sources to control when they do and do not emit light,
wherein the controller is configured to:
control the width of the pulses to control the total power of the light emitted into the fibre, and
optimise overlap times during which the light sources are activated simultaneously so that the overlap time between the light sources is minimised when light from one light source falls near the peak of a Raman gain spectrum produced from light of another light source.

2. The pump unit according to claim 1, wherein the controller comprises a pulse width modulation, PWM, unit for varying the width of the pulses.

3. The pump unit according to claim 1, wherein the controller is configured to vary the duty cycles of the pulses to each of the light sources in response to changes in gain conditions, bandwidth and/or channel allocation in the amplifier.

4. The pump unit according to claim 1, configured to allow a long overlap time between two light sources when light from the two sources does not interact strongly.

5. The pump unit according to claim 1, wherein each of the light sources is configured to emit light at a high pump power.

6. The pump unit according to claim 1, wherein each of the light sources is configured to operate in multi longitudinal mode.

7. The pump unit according to claim 1, wherein each of the light sources is configured to operate in coherence collapse mode.

8. The pump unit according to claim 1, wherein the controller and the light sources are provided in an integrated package.

9. The pump unit according to claim 1, wherein each of the light sources is configured to emit counter-propagating light travelling in the opposite direction to the optical signal passing along the fibre.

10. The pump unit according to claim 1, wherein each of the light sources is a laser.

11. A Raman amplifier assembly having an optical fibre carrying an optical signal, the assembly comprising:
at least two light sources for emitting light at different wavelengths into the fibre to induce Raman gain of the optical signal passing along the fibre; and
a controller for providing pulses to each of the light sources to control when they do and do not emit light, wherein the controller is configured to:
control the width of the pulses to control the total power of the light emitted into the fibre, and
optimise overlap times during which the light sources are activated simultaneously so that the overlap time between the light sources is minimised when light from one light source falls near the peak of a Raman gain spectrum produced from light of another light source.

12. The Raman amplifier assembly according to claim 11, further comprising a pump unit according to claim 1.

13. A method of controlling a pump unit used in a Raman amplifier system having an optical fibre for carrying an optical signal, the method comprising:
emitting light at different wavelengths into the fibre to induce Raman gain of the optical signal passing along the fibre by means of light sources;
providing pulses to each of the light sources to control when they do and do not emit light; and
varying the width of the pulses to control the total power of the light emitted into the fibre, and
optimising overlap times during which the light sources are activated simultaneously so that the overlap time between the light sources is minimised when light from one light source falls near the peak of a Raman gain spectrum produced from light of another light source.

14. A computer program, comprising computer readable code which, when run by a unit, causes the unit to perform the method of claim 13.

15. A computer program, comprising computer readable code which, when run by a controller of a pump unit, causes the pump unit to operate as the pump unit of claim 1.

16. A computer program product comprising a computer readable medium and a computer program according to claim 14, wherein the computer program is stored on the computer readable medium.

17. A computer program product comprising a computer readable medium and a computer program according to claim 15, wherein the computer program is stored on the computer readable medium.
